(19) United States
(12) Patent Application Publication
(10) Pub. No.: US 2016/0227568 A1
(43) Pub. Date: Aug. 4, 2016

(54) Method of Handling Carrier Grouping and Related Communication Device

(71) Applicant: HTC Corporation, Taoyuan City (TW)

(72) Inventor: Chi-Fang Li, Taoyuan City (TW)

(21) Appl. No.: 15/011,690

(22) Filed: Feb. 1, 2016

Related U.S. Application Data
(60) Provisional application No. 62/109,637, filed on Jan. 30, 2015.

(51) Int. Cl. H04W 72/12; H04L 5/14; H04W 72/14; H04W 72/04

(52) U.S. Cl. CPC H04W 72/1278; H04W 72/042; H04L 5/14; H04W 72/14

(57) ABSTRACT

A communication device of handling a carrier grouping comprises a storage unit for storing instructions and a processing means coupled to the storage unit. The processing means is configured to execute the instructions stored in the storage unit. The instructions comprise receiving a message for grouping at least one component carrier into a carrier group; receiving a control information for the at least one component carrier of the carrier group from a network; and performing a communication operation with the network via the at least one component carrier according to the control signal.

### CROSS REFERENCE TO RELATED APPLICATIONS

This application claims the benefit of U.S. Provisional Application No. 62/109,637, filed on Jan. 30, 2015, which is incorporated herein by reference.

### BACKGROUND OF THE INVENTION

1. Field of the Invention

The present invention relates to a method and communication device used in a wireless communication system, and more particularly, to a method and communication device of handling a carrier grouping in a wireless communication system.

2. Description of the Prior Art

A long-term evolution (LTE) system supporting the 3rd Generation Partnership Project (3GPP) Rel-8 standard and/or the 3GPP Rel-9 standard are developed by the 3GPP as a successor of the universal mobile telecommunication system (UMTS) for further enhancing performance of the UMTS to satisfy increasing needs of users. The LTE system includes a new radio interface and a new radio network architecture that provides high data rate, low latency, packet optimization, and improved system capacity and coverage. In the LTE system, a radio access network known as an evolved universal terrestrial radio access network (E-UTRAN) includes at least one evolved Node-B (eNB) for communicating with at least one user equipment (UE), and for communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at the coverage edge of an eNB, increases peak data rate and throughput, and includes advanced techniques, such as carrier aggregation (CA), coordinated multipoint (CoMP) transmissions/reception, uplink (UL) multiple-input multiple-output (UL-MIMO), licensed-assisted access (LAA) using LTE, etc.

Carriers are used by the eNB and the UE for communicating with each other. The CA is introduced to the LTE-A system by which more than one component carriers are aggregated to achieve a wide-band transmission. When the UE is configured with the CA, the UE is able to receive and/or transmit data and/or signal on one or multiple component carriers. However, a larger amount of control information is needed for using (e.g., configuring, arranging, etc.) the component carriers. The overhead for transmitting the control information is thus large. The benefit obtained according to the CA is degraded if the overhead is not handled properly.

Thus, reduction of the overhead the control information for the component carriers is an important problem to be solved.

### SUMMARY OF THE INVENTION

The present invention therefore provides a method and related communication device for handling a carrier grouping to solve the abovementioned problem.

A communication device of handling a carrier grouping comprises a storage unit for storing instructions and a processing means coupled to the storage unit. The processing means is configured to execute the instructions stored in the storage unit. The instructions comprise receiving a message for grouping at least one component carrier into a carrier group; receiving a control information for the at least one component carrier of the carrier group from a network; and performing a communication operation with the network via the at least one component carrier according to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is an example of carriers in licensed bands (carriers for Licensed Bands: FDD, TDD, FDD-DL only).

FIG. 5 is an example of carriers in unlicensed bands (carriers for ISM Bands: TDD, 2.4 GHz, 5 GHz).

FIG. 6 is an example of carriers aggregation (multiple CCs are used for eNBs and UEs).

FIG. 7 is an example of grouping of multiple licensed carriers.

FIG. 8 is an example of grouping of multiple unlicensed carriers.

FIG. 9 is an example of grouping of licensed and unlicensed carriers.

FIG. 10 is an example of grouping of unlicensed carriers for a component carrier.

### DETAILED DESCRIPTION

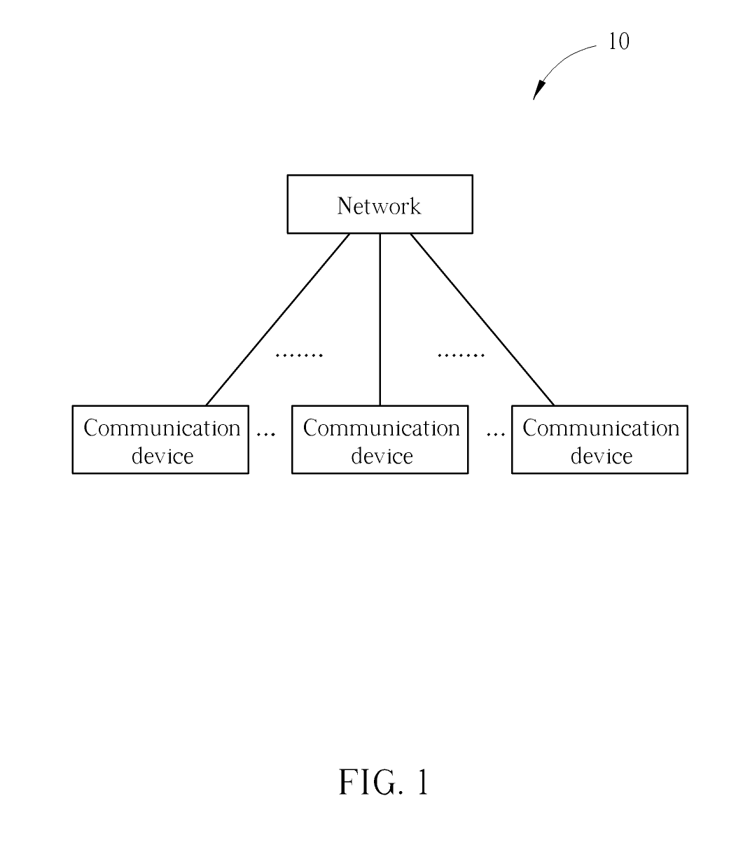

Please refer to FIG. 1, which is a schematic diagram of a wireless communication system 10 according to an example of the present invention. The wireless communication system 10 is briefly composed of a network and a plurality of communication devices. The network and a communication device may communicate with each other via one or more carriers of licensed band(s) and/or unlicensed band(s). A carrier of the licensed band(s) may be a frequency-division duplexing (FDD) carrier pair, a time-division duplexing (TDD) carrier, or a FDD-downlink (FDD-DL) only carrier. A carrier of the unlicensed band(s) may be a TDD carrier, a FDD-DL only carrier, or a FDD-uplink (FDD-UL) only carrier. One or more carriers of the licensed/unlicensed band(s) may be used as a component carrier in CA. Multiple component carriers may be aggregated for the network and the communication devices communicating with each other according to the CA.

In FIG. 1, the network and the communication devices are simply utilized for illustrating the structure of the wireless communication system 10. Practically, the network may be an evolved UTRAN (E-UTRAN) including at least one evolved NB (eNB) and/or at least one relay in a long term evolution (LTE) system, a LTE-Advanced (LTE-A) system or an evolution of the LTE-A system. The eNB or the relay may be termed as a base station.

A communication device may be a user equipment (UE), a low cost device (e.g., machine type communication (MTC) device) , a device-to-device (D2D) device, a mobile phone, a laptop, a tablet computer, an electronic book, a portable computer system, a vehicle, airplane or combination thereof. In addition, the network and the communication device can be seen as a transmitter or a receiver according to direction (i.e., transmission direction), e.g., for an UL, the communication device is the transmitter and the network is the receiver, and for a DL, the network is the transmitter and the communication device is the receiver.

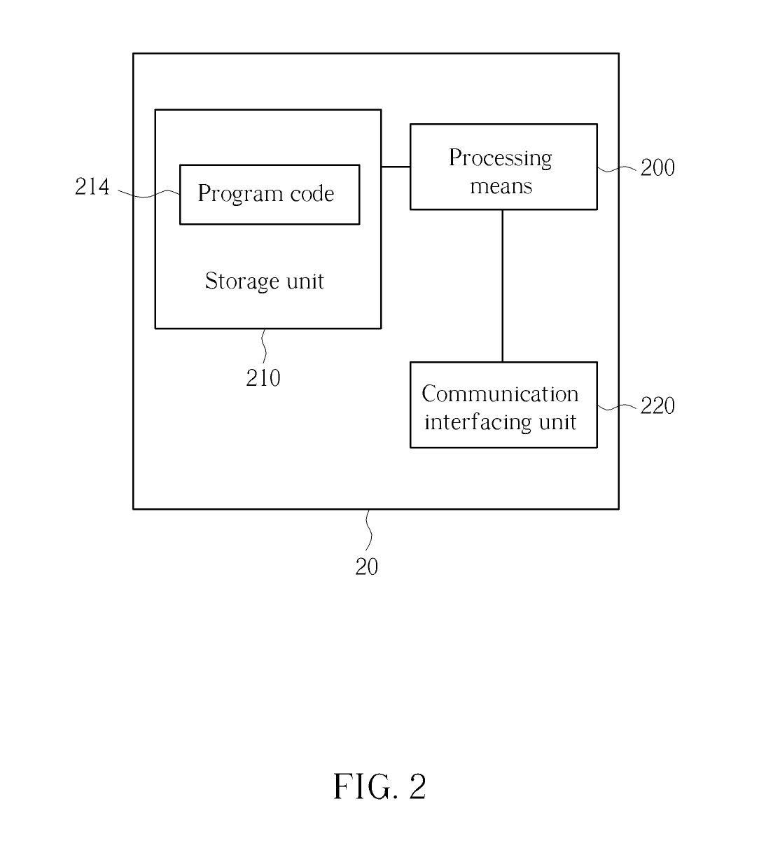

FIG. 2 is a schematic diagram of a communication device 20 according to an example of the present invention. The communication device 20 may be a communication device or the network shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that may store a program code 214, accessed and executed by the processing means 200. Examples of the storage unit 210 include but are not limited to a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), magnetic tape, hard disk, optical data storage device, non-volatile storage unit, non-transitory computer-readable medium (e.g., tangible media), etc. The communication interfacing unit 220 is preferably a transceiver and is used to transmit and receive signals (e.g., data, messages and/or packets) according to processing results of the processing means 200.

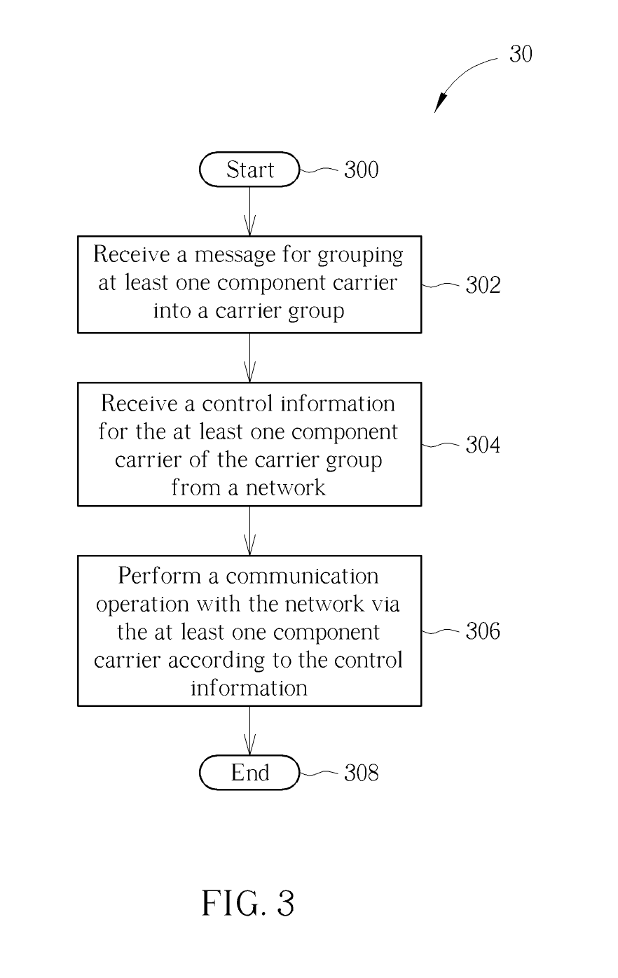

FIG. 3 is a flowchart of a process 30 according to an example of the present invention. The process 30 may be utilized in a communication device or the network shown in FIG. 1, to handle a carrier grouping. The process 30 may be compiled into the program code 214 and includes the following steps:

Step 300: Start.

Step 302: Receive a message for grouping at least one component carrier into a carrier group.

Step 304: Receive a control information for the at least one component carrier of the carrier group from a network.

Step 306: Perform a communication operation with the network via the at least one component carrier according to the control information.

Step 308: End.

According to the process 30, the communication device may receive a message for grouping at least one component carrier (e.g., 1, 2, 3, 4 or 5 component carriers) into a carrier group. Then, the communication device may receive a control information (e.g., control signal) for the at least one component carrier of the carrier group from a network, and perform a communication operation (e.g., transmission and/or reception of data) with the network via the at least one component carrier according to the control information. That is, a single control information is used for all component carrier(s) in the carrier group, and the communication devices does not to receive multiple control information for multiple component carrier. Thus, overhead for transmitting/receiving the control information is reduced. As a result, throughput of the communication device and the network can be improved.

Realization of the process 30 is not limited to the above description.

In one example, the at least one component carrier may include at least one of the FDD carrier pair, the FDD-UL only carrier, the FDD-DL only carrier, and the TDD carrier. That is, the at least one component carrier may include one or more FDD carrier pair(s), one or more FDD-UL only carrier(s), one or more FDD-DL only carrier(s) and/or one or more TDD carrier(s).

In one example, the at least one component carrier may be in a licensed band. In one example, the at least one component carrier maybe in an unlicensed band (e.g., industrial, scientific and medical (ISM) band). In one example, a first set of the at least one component carrier may be in a licensed band, and a second set of the at least one component carrier maybe in the unlicensed band. That is, at least one carrier location of the at least one component carrier may be arbitrary.

In one example, the control information may be transmitted in a physical DL control channel (PDCCH). In one example, the control information may be transmitted via one of the at least one component carrier. That is, rest of the at least one component carrier may not be used for transmitting the control information. In other words, the control information may be transmitted via only one of the at least one component carrier, and resource of the rest of the at least one component carrier can be saved.

In one example, the control information may include a UL grant and/or scheduling information (e.g., for resource allocation). In one example, the control information may be for a subset of the at least one component carrier of the carrier group. That is, the subset (e.g., part or all) of the at least one component carrier of the carrier group maybe scheduled and/or configured by the control information. In one example, a subset of the control information may be for the subset of the at least one component carrier of the carrier group. That is, the subset of the at least one component carrier of the carrier group may be scheduled and/or configured by the subset (e.g., part or all) of the control information. The subset of the control information may include modulation and coding scheme (MCS) level(s), resource allocation, etc., and is not limited herein.

In one example, the control information may be for at least one component carrier of another carrier group. That is, the control information may be not only for the at least one component carrier of the carrier group, but also for the at least one component carrier of another carrier group. Thus, the control information may be used for one or more carrier groups.

In one example, a number of the at least one component carrier and a number of at least one component carrier of another carrier group may be the same. In another example, the number of the at least one component carrier and the number of the at least one component carrier of another carrier group maybe different. That is, the sizes of the carrier groups may be the same or different.

In one example, the communication device may perform carrier sensing (e.g., by measuring energy or power density of the component carrier) to determine an availability of the at least one component carrier, and may perform the communication operation (e.g., transmission and/or reception of data) via the at least one component carrier according to the control signal and the availability, e.g., if the at least one component carrier is in the unlicensed band. In one example, the communication device may receive the availability of the at least one component carrier from the network, and may perform the communication operation (e.g., transmission and/or reception of data) via the at least one component carrier according to the control signal and the availability, e.g., if the at least one component carrier is in the unlicensed band. That is, the availability may be determined by the communication device or the network.

In one example, the communication operation may be performed via one of the at least one component carrier. Further, the one of the at least one component carrier may be selected randomly, according to at least one availability of the at least one component carrier, according to a sequence (e.g., a grouping order) of the at least one component carrier, or according to at least one carrier frequency (e.g., a frequency order) of the at least one component carrier. In one example, the one of the at least one component carrier may be configured (e.g., signaled) by the network. That is, the component carrier for performing the communication operation may be determined arbitrarily. In one example, rest of the at least one component carrier may not be used for performing the communication operation. That is, the communication operation may be performed via only one of the at least one component, and resource of the rest of the at least one component carrier can be saved.

In one example, the communication operation may be performed according to the CA defined in a 3rd Generation Partnership Project (3GPP) standard. That is, the component carrier(s) mentioned above may be operated according to the 3GPP standard.

Several embodiments of the invention are presented by using terminologies of LTE/LTE-Advanced system in the following while the invention is not limited to be applicable in LTE/LTE-advanced systems.

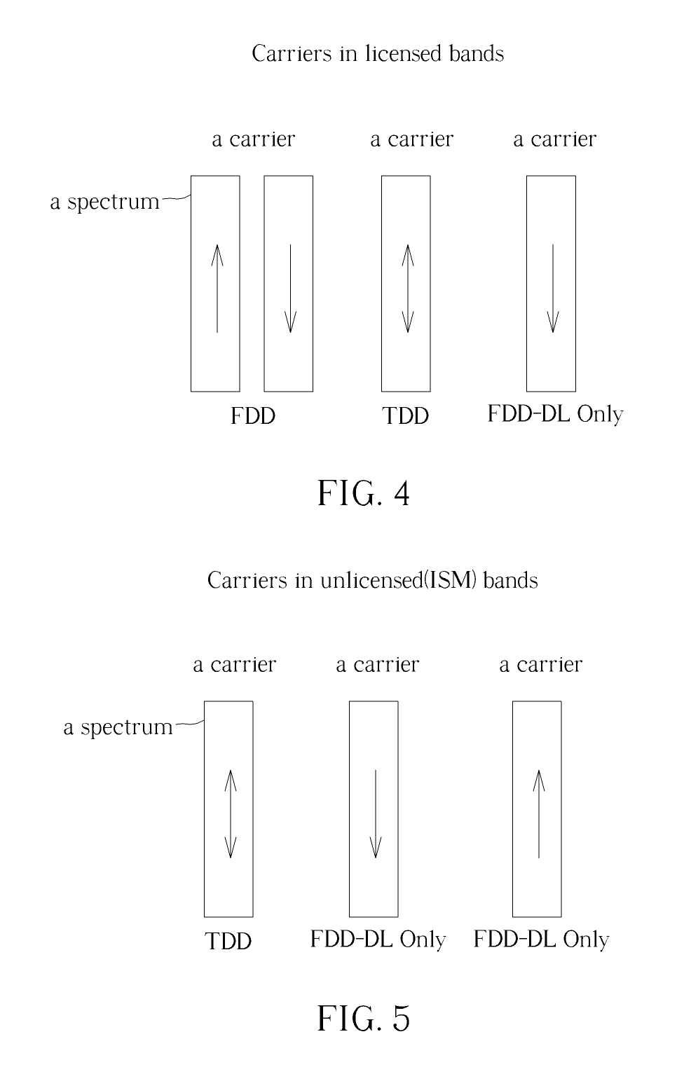

FIG. 4 shows carriers used for FDD, TDD, FDD-DL only. One or multiple of these carriers are going to be used as a component carrier in carrier aggregation or for normal transmission (without carrier aggregation).

FIG. 5 shows carriers in unlicensed band. One or multiple of these carriers are going to be used as a component carrier in carrier aggregation or for normal transmission (without carrier aggregation).

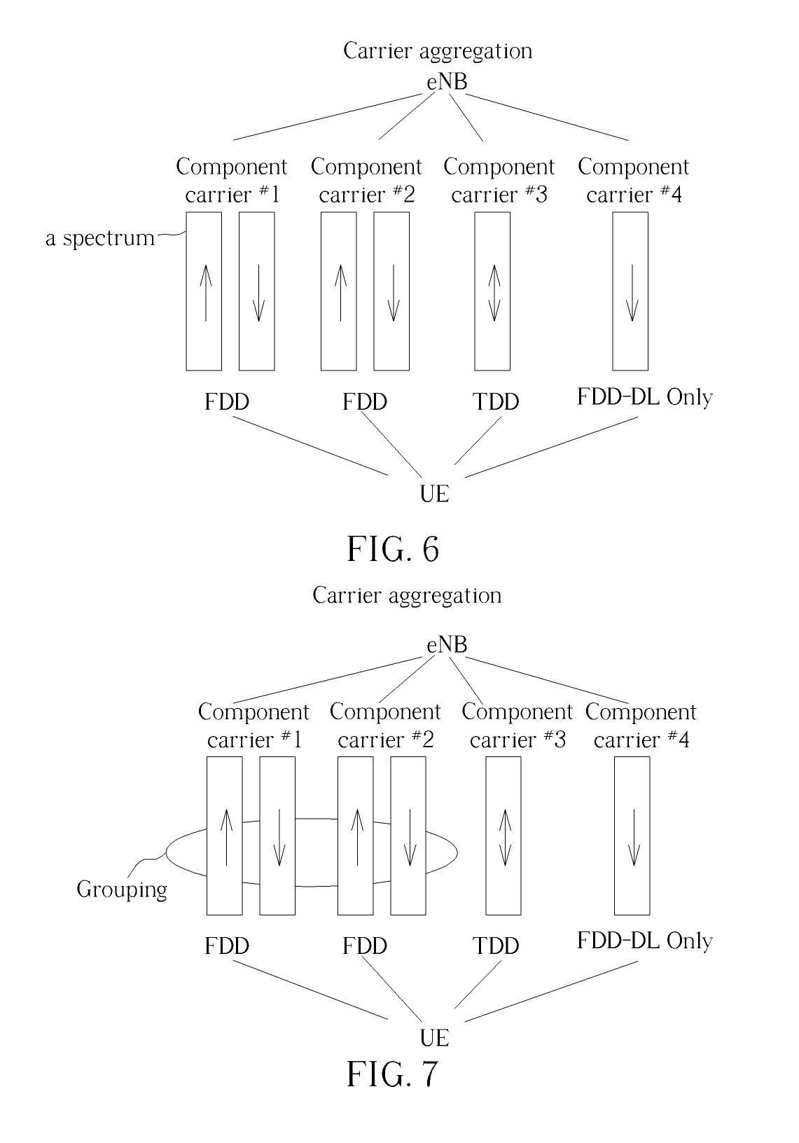

FIG. 6 illustrates the concept of carrier aggregation. Multiple carriers are aggregated for transmission and reception between an eNB and a UE.

An embodiment of the invention is a grouping method and apparatuses sharing downlink control in carrier aggregation. Carriers are used for communications between eNB and UEs. A carrier can be a pair of downlink and uplink spectrums (FDD), a spectrum for both downlink and uplink (TDD), or a spectrum for downlink only (FDD Downlink only).

One or multiple carriers are grouped as one carrier group. For example, two, three, four, or five carriers are grouped as one carrier group. There can be one or multiple carrier groups having equal or different numbers of carriers in groups.

When an eNB transmit downlink control signals and/or uplink grant and/or uplink resource scheduling for carriers, the eNB transmit one set of them for a carrier group. All carriers in the group make use of the same set of downlink control signals and/or uplink grant and/or uplink resource scheduling as their downlink controls signals and/or uplink grant and/or uplink resource scheduling.

For example, in an LTE system, an eNB transmits a PDCCH for each carrier as its downlink control signals to facilitate downlink receiving and uplink transmission. While applying the presented invention, an eNB will transmit only one PDCCH for one carrier group. The PDCCH would be used as the PDCCH for each carrier in the group. That is all carriers in the same group make use the same PDCCH. Other downlink control signals and/or information in LTE/LTE-Advanced systems can be similarly shared as the same between carriers in the same group.

Because each carrier group might include equal or different numbers of carries, there would be equal or different numbers of carries making use of their group's downlink control signals and/or uplink grant and/or uplink resource scheduling.

The set of downlink control signals and/or uplink grant and/or uplink resource scheduling is transmitted on one of carriers in each group. The carrier can be identify by eNB when configuring the group or it can be the first, middle, or the last carrier in the group according grouping order, frequency order, etc. The eNB might reconfigure the grouping when it is necessary.

FIG. 7 illustrates an example of grouping multiple (licensed) FDD carriers. These carriers in the same group make use of the same downlink control signals and/or information.

It's also a feasible way that only partial of downlink control signals and/or uplink grant and/or uplink resource scheduling are the same for all carriers in a carrier group. For example, only a part of downlink control signals in PDCCH are shared by all carriers in a group. MCS level, Resource Allocation, etc. could be the same for all carriers in a group. The remaining downlink control signals would be different between carriers in a group. These remaining downlink control signals are transmitted, additional to the shared, common PDCCH. It can be, for example, transmitted in PDCCH of each carrier, respectively. The shared downlink control signals and/or information are further shared and the same for two or more carrier groups.

The transmission/reception from eNB to UE or from UE to eNB takes place via one of carriers in a group by making use of the above downlink control signals and/or information. The carriers in the same group make use the same downlink control signals and/or information for their transmission and reception.

Another embodiment of the invention is a grouping method and apparatuses sharing downlink control in carrier aggregation in which one or more than one component carriers is in unlicensed bands. Carriers in unlicensed bands, e.g. ISM bands, are used for communications between eNB and UEs. A carrier can be a spectrum for both downlink and uplink (TDD), a spectrum for downlink only, or a spectrum for uplink only.

Before transmissions, it is required to detect whether a carrier is used by others. A detect method can be one of the following. An eNB detect the whether a carrier is used or not by measuring energy, power density, etc. on the carrier. After the eNB learns one carrier is available, the eNB can signal the related information of the available carrier to the UE for subsequent transmission and/or reception. Another way is that a UE detect the whether a carrier is used or not by measuring energy, power density, etc. on the carrier. After the UE learns one carrier is available, the UE can signal the related information of the available carrier to the eNB for subsequent transmission and/or reception. Another possible way is that the network signals the eNB and/or the UE to make use of one carrier among available ones in an ISM band. The transmission and reception occur after the availability of a carrier is checked.

One or multiple of these carriers in an unlicensed band are grouped as one carrier group. For example, two, three, four, or five carriers are grouped as one carrier group. There can be one or multiple carrier groups having equal or different numbers of carriers in groups.

When an eNB transmit downlink control signals and/or uplink grant and/or uplink resource scheduling for carriers, the eNB transmit one set of them for a carrier group. All carriers in the group make use of the same set of downlink control signals and/or uplink grant and/or uplink resource scheduling as their downlink controls signals and/or uplink grant and/or uplink resource scheduling.

For example, in an LTE system, an eNB transmits a PDCCH for each carrier as its downlink control signals to facilitate downlink receiving and uplink transmission. While applying the presented invention, an eNB will transmit only one PDCCH for one carrier group. The PDCCH would be used as the PDCCH for each carrier in the group. That is all carriers in the same group make use the same PDCCH. Other downlink control signals and/or information in LTE/LTE-Advanced systems can be similarly shared as the same between carriers in the same group.

Because each carrier group might include equal or different numbers of carries, there would be equal or different numbers of carries making use of their group's downlink control signals and/or uplink grant and/or uplink resource scheduling.

The set of downlink control signals and/or uplink grant and/or uplink resource scheduling is transmitted on one of carriers in each group. The carrier can be identify by eNB when configuring the group or it can be the first, middle, or the last carrier in the group according grouping order, frequency order, etc. The eNB might reconfigure the grouping when it is necessary.

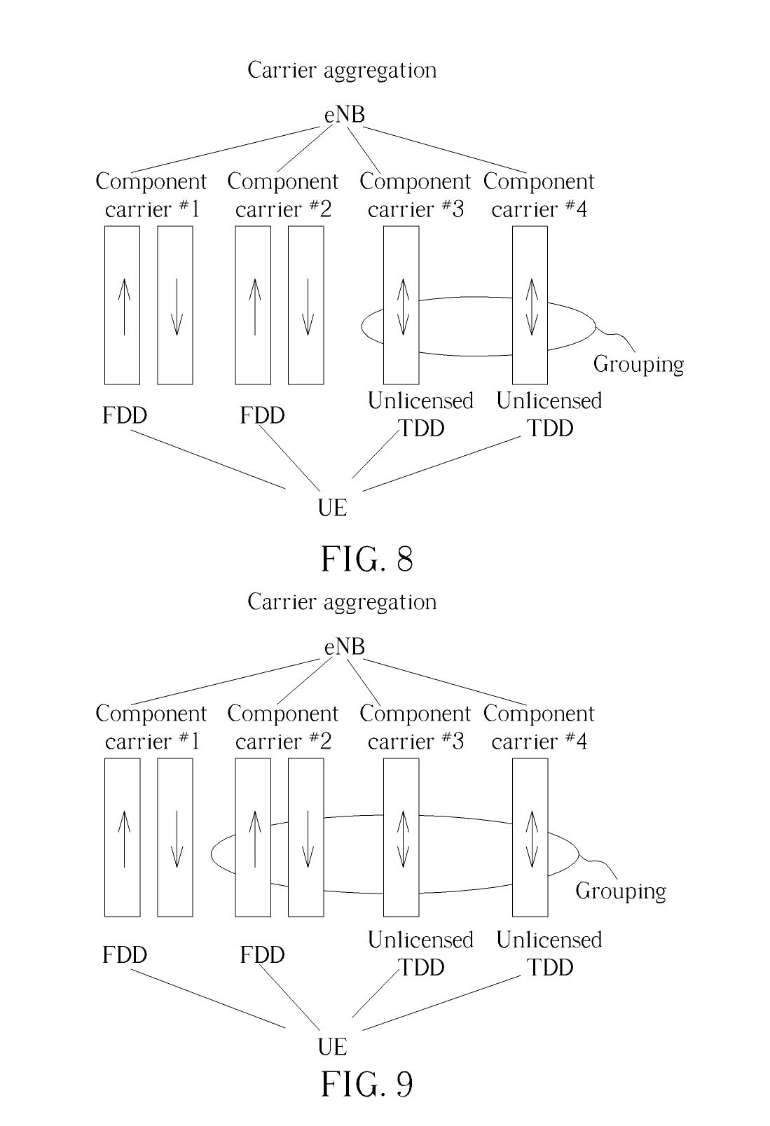

FIG. 8 illustrates an example of grouping multiple unlicensed carriers. These carriers in the same group make use of the same downlink control signals and/or information.

It is also possible that only partial of downlink control signals and/or uplink grant and/or uplink resource scheduling are the same for all carriers in a carrier group. For example, only a part of downlink control signals in PDCCH are shared by all carriers in a group. MCS level, Resource Allocation, etc. could be the same for all carriers in a group. The remaining downlink control signals would be different between carriers in a group. These remaining downlink control signals are transmitted, additional to the shared, common PDCCH. It can be, for example, transmitted in PDSCH of each carrier, respectively. It is also possible that the shared downlink control signals and/or information are further shared and the same for two or more carrier groups.

The transmission/reception from eNB to UE or from UE to eNB takes place via one of carriers in a group by making use of the above downlink control signals and/or information. The carriers in the same group make use the same downlink control signals and/or information for their transmission and reception.

Another embodiment of the invention is a grouping method and apparatuses sharing downlink control in carrier aggregation in which one or more than one component carrier is in an unlicensed band and one or more than one carrier is in a licensed band. Carriers in licensed bands are used for communications between eNB and UEs. A carrier can be a pair of downlink and uplink spectrums (FDD), a spectrum for both downlink and uplink (TDD), or a spectrum for downlink only (FDD Downlink only). Carriers in unlicensed bands, e.g. ISM bands, are used for communications between eNB and UEs. A carrier can be a spectrum for both downlink and uplink (TDD), a spectrum for downlink only, or a spectrum for uplink only.

One or multiple carriers in licensed and unlicensed bands are grouped as one carrier group. For example, two, three, four, or five carriers are grouped as one carrier group and in the group there are at least one licensed carrier and one unlicensed carrier. There can be one or multiple carrier groups having equal or different numbers of carriers in groups.

When an eNB transmit downlink control signals and/or uplink grant and/or uplink resource scheduling for carriers, the eNB transmit one set of them for a carrier group. All carriers in the group make use of the same set of downlink control signals and/or uplink grant and/or uplink resource scheduling as their downlink controls signals and/or uplink grant and/or uplink resource scheduling.

For example, in an LTE system, an eNB transmits a PDCCH for each carrier as its downlink control signals to facilitate downlink receiving and uplink transmission. While applying the presented invention, an eNB will transmit only one PDCCH for one carrier group. The PDCCH would be used as the PDCCH for each carrier in the group. That is all carriers in the same group make use the same PDCCH. Other downlink control signals and/or information in LTE/LTE-Advanced systems can be similarly shared as the same between carriers in the same group.

Because each carrier group might include equal or different numbers of carries, there would be equal or different numbers of carries making use of their group's downlink control signals and/or uplink grant and/or uplink resource scheduling.

The set of downlink control signals and/or uplink grant and/or uplink resource scheduling is transmitted on one of carriers in each group. The carrier can be identify by eNB when configuring the group or it can be the first, middle, or the last carrier in the group according grouping order, frequency order, etc. The eNB might reconfigure the grouping when it is necessary.

FIG. 9 illustrates an example of grouping licensed and unlicensed carriers. These carriers in the same group make use of the same downlink control signals and/or information.

It is also feasible that only partial of downlink control signals and/or uplink grant and/or uplink resource scheduling are the same for all carriers in a carrier group. For example, only a part of downlink control signals in PDCCH are shared by all carriers in a group. MCS level, Resource Allocation, etc. could be the same for all carriers in a group. The remaining downlink control signals would be different between carriers in a group. These remaining downlink control signals are transmitted, additional to the shared, common PDCCH. It can be, for example, transmitted in PDSCH of each carrier, respectively. When there are more than two groups, the shared downlink control signals and/or information are further shared and the same for two or more carrier groups.

The transmission/reception from eNB to UE or from UE to eNB takes place via one of carriers in a group by making use of the above downlink control signals and/or information. The carriers in the same group make use the same downlink control signals and/or information for their transmission and reception.

Another embodiment of the invention is a grouping method and apparatuses sharing downlink control between carriers in a group wherein at least one of carriers in the group is not a component carrier in the operation in carrier aggregation. All above-mentioned methods and apparatuses are used in non-carrier aggregation transmission, i.e. multiple carriers are grouped to share the same set or partial of the same set downlink control signals. The transmission and/or reception on carriers in a group will refer to the downlink control signaling of the group.

The transmission/reception from eNB to UE or from UE to eNB takes place via one of carriers in a group by making use of the above downlink control signals and/or information. The carriers in the same group make use the same downlink control signals and/or information for their transmission and reception.

Another embodiment of the invention is in all above mentioned grouping methods and apparatuses, the transmission/reception from eNB to UE or from UE to eNB takes place in one of carriers in a group when the carrier is identified as available. Only one transmission/reception occurs in a carrier and no need to transmit/receive the same content in another carrier in the group. The identification of the availability can accord to resource allocation in downlink control signaling or the energy detection result of a carrier in unlicensed band by the network (e.g. eNB) and/or the communication device. When there are more than carriers are available, one would be chosen randomly, in turn, by frequency, etc. as the carrier for transmission and/or reception.

The transmission/reception from eNB to UE or from UE to eNB takes place via one of carriers in a group by making use of the above downlink control signals and/or information. The carriers in the same group make use the same downlink control signals and/or information for their transmission and reception.

Another embodiment of the invention is in all above mentioned grouping methods and apparatuses, one component carrier in carrier aggregation can correspond to one of carriers in a group. That means the component carrier corresponds to the group and one of carriers in the group will be used for the transmission and/or reception of the component carrier. The transmission/reception from eNB to UE or from UE to eNB on a component carrier takes place in one of carriers in a group when the carrier is identified as available. Only one transmission/reception occurs in a carrier of the group and no need to transmit/receive the same content in another carrier in the group.

The identification of the availability can accord to resource allocation in downlink control signaling or the energy detection result of a carrier in unlicensed band by the network (e.g. eNB) and/or the communication device. When there are more than carriers are available, one would be chosen randomly, orderly in turn, by frequency, etc. as the carrier for transmission and/or reception.

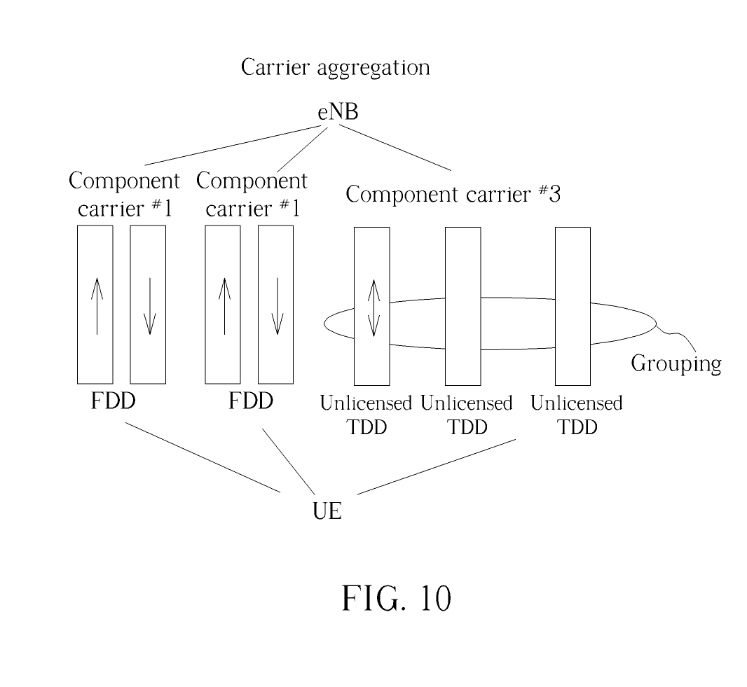

FIG. 10 illustrates an example of grouping multiple unlicensed carriers to be used for a component carrier. Only one of the carriers in a group is used for transmission/reception when the carrier is detected as available.

One carrier can correspond to one of carriers in a group. That means the carrier corresponds to the group and one of carriers in the group will be used for the transmission and/or reception of the carrier. The transmission/reception from eNB to UE or from UE to eNB on a carrier takes place in one of carriers in a group when the carrier is identified as available. Only one transmission/reception occurs in a carrier of the group and no need to transmit/receive the same content in another carrier in the group.

The identification of the availability can accord to resource allocation in downlink control signaling or the energy detection result of a carrier in unlicensed band by the network (e.g. eNB) and/or the communication device. When there are more than carriers are available, one would be chosen randomly, orderly in turn, by frequency, etc. as the carrier for transmission and/or reception.

Another embodiment of the invention is in all above mentioned grouping methods and apparatuses, the transmission/reception takes place in multiple carriers in a group. The reception eNB or UE would receive on each carrier respectively and choose one been received correctly. Or the reception eNB or UE would combine received signals on multiple carriers for frequency diversity and come out a result of reception.

The transmission/reception from eNB to UE or from UE to eNB takes place via one of carriers in a group by making use of the above downlink control signals and/or information. The carriers in the same group make use the same downlink control signals and/or information for their transmission and reception.

It should be noted that although the above examples are illustrated based on the process 30. The examples can be combined and/or modified arbitrarily according to system requirements and/or design considerations.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20.

To sum up, the present invention provides a method and related communication device for handling a carrier grouping. One or more component carriers in the same carrier group may share the same control information. Thus, overhead for transmitting/receiving the control information is reduced. As a result, throughput of the communication device and the network can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device of handling a carrier grouping, comprising:
a storage unit, for storing instructions of:
receiving a message for grouping at least one component carrier into a carrier group;
receiving a control information for the at least one component carrier of the carrier group from a network; and
performing a communication operation with the network via the at least one component carrier according to the control signal; and
a processing means, coupled to the storage unit, configured to execute the instructions stored in the storage unit.

2. The communication device of claim 1, wherein the at least one component carrier comprises at least one of a frequency-division duplexing (FDD) carrier pair, a FDD-uplink (FDD UL) only carrier, a FDD-downlink (FDD DL) only carrier, and a time-division duplexing (TDD) carrier.

3. The communication device of claim 1, wherein the at least one component carrier is in a licensed band.

4. The communication device of claim 1, wherein a first set of the at least one component carrier is in a licensed band, and a second set of the at least one component carrier is in an unlicensed band.

5. The communication device of claim 1, wherein the control information is transmitted in a physical DL control channel (PDCCH).

6. The communication device of claim 1, wherein the control information is transmitted via one of the at least one component carrier.

7. The communication device of claim 1, wherein the control information comprises a UL grant and/or scheduling information.

8. The communication device of claim 1, wherein the control information is for a subset of the at least one component carrier of the carrier group.

9. The communication device of claim 1, wherein the control information is for at least one component carrier of another carrier group.

10. The communication device of claim 1, wherein a number of the at least one component carrier and a number of at least one component carrier of another carrier group are different.

11. The communication device of claim 1, wherein the at least one component carrier is in an unlicensed band.

12. The communication device of claim 11, wherein the storage unit further stores an instruction of:
performing carrier sensing to determine an availability of the at least one component carrier; and
performing the communication operation via the at least one component carrier according to the control signal and the availability.

13. The communication device of claim 11, wherein the storage unit further stores an instruction of:
receiving an availability of the at least one component carrier from the network; and
performing the communication operation via the at least one component carrier according to the control signal and the availability.

14. The communication device of claim 1, wherein the communication operation is performed via one of the at least one component carrier.

15. The communication device of claim 14, wherein the one of the at least one component carrier is selected randomly, according to at least one availability of the at least one component carrier, according to a sequence of the at least one component carrier, or according to at least one carrier frequency of the at least one component carrier.

16. The communication device of claim 14, wherein rest of the at least one component carrier is not used for performing the communication operation.

17. The communication device of claim 1, wherein the communication operation is performed according to a carrier aggregation (CA) defined in a 3rd Generation Partnership Project (3GPP) standard.
